(19) United States
(12) Patent Application Publication
(10) Pub. No.: US 2016/0098686 A1
(43) Pub. Date: Apr. 7, 2016

(54) REFERRAL AND RECRUITMENT PLATFORM

(71) Applicant: Boon Company Inc., Culver City, CA (US)

(72) Inventor: Dakota Younger, Culver City, CA (US)

(21) Appl. No.: 14/873,356

(22) Filed: Oct. 2, 2015

Related U.S. Application Data
(60) Provisional application No. 62/059,319, filed on Oct. 3, 2014.

(51) Int. Cl. G06Q 10/10

(52) U.S. Cl. CPC G06Q 10/1053

(57) ABSTRACT

Referral and recruiting methods and systems may be enabled to receive a user profile associated with a first candidate; receive a company profile associated with a company; receive a job posting from the company; receive a referral for the job posting from a referring user, wherein receiving the referral for the job posting comprises: receiving an association of the job posting and the first candidate, and providing the job posting to the first candidate; track the referral, wherein tracking the referral comprises: associating the referral with the referring user and the first candidate, and preventing other users from referring the job posting to the first candidate; and administer the referral, wherein administering the referral comprises providing a referral fee to the referring user.

### RELATED APPLICATION

Under provisions of 35 U.S.C. §119(e), the Applicant claims the benefit of U.S. provisional application No. 62/059,319, filed Oct. 3, 2014, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to online referral and recruitment in a networking environment.

### BRIEF OVERVIEW

A referral and recruitment platform may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Referral and recruiting methods and systems may be enabled to receive a user profile associated with a first candidate; receive a company profile associated with a company; receive a job posting from the company; receive a referral for the job posting from a referring user, wherein receiving the referral for the job posting comprises: receiving an association of the job posting and the first candidate, and providing the job posting to the first candidate; track the referral, wherein tracking the referral comprises: associating the referral with the referring user and the first candidate, and preventing other users from referring the job posting to the first candidate; and administer the referral, wherein administering the referral comprises providing a referral fee to the referring user.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. In the drawings:

FIG. 1 is a diagram showing the basic platform structure;

FIG. 2 is a flow chart of a method for providing referral-recruiting platform;

FIG. 3 is a sample screenshot showing an embodiment of a user profile with a job posting who is not connected to the network;

FIG. 4 is a sample screenshot showing an embodiment of a user profile with a job posting who is connected to the network;

FIG. 5 is a sample screenshot showing an embodiment of a potential referral user's profile;

FIG. 6 is a sample screenshot showing another embodiment of a potential referral user's profile;

FIG. 7 is a sample screenshot showing an embodiment of job posting;

FIG. 8 is a block diagram of a system including a computing device for performing the method of FIG. 2;

FIG. 9 illustrates an interface in which a plurality of individual profiles are displayed;

FIGS. 10-12 illustrate a full listing of requests may be displayed in a notification style interface;

FIG. 13 illustrates an interface in which a user may be provided with a listing of tracked referrals;

FIG. 14 illustrates an interface in which a posting may be forwarded or shared with others;

FIG. 15 illustrates a messaging interface;

FIG. 16 illustrates an interface in which the referral may be displayed to a receiving entity;

FIG. 17 illustrates an interface in which a user's ratings are displayed;

FIG. 18 illustrates one embodiment of a payment interface;

FIG. 19 illustrates a list of contacts; and

FIG. 20 illustrates a list of contacts and associated match percentages for a job posting.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. As should be understood, any embodiment may incorporate only one or a plurality of the above-disclosed aspects of the display and may further incorporate only one or a plurality of the above-disclosed features. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Although the present disclosure is written with reference to human resource and employment, it should be understood that the scope of the platform implementation is anticipated to include license transactions, purchases, and contractual based transactions for products and services.

I. Platform Overview

Consistent with embodiments of the present disclosure, a referral and recruitment platform may be provided. This overview is provided to introduce a selection of concepts in a simplified form that is further described below. This overview is not intended to identify key features or essential features of the claimed subject matter. Nor is this overview intended to be used to limit the claimed subject matter's scope. The referral and recruitment platform may be used by individuals or companies to connect those seeking to employ human resource with those who refer to the human resource for employment.

Accordingly, embodiments of the present disclosure may enable individuals to leverage their contacts and receive compensation for successful hiring of contacts referred through the platform. Contacts may include individuals as well as companies. As such, users of the platform may include individuals, groups or companies.

Embodiments of the present disclosure may enable a platform user to post updates. The updates may include, but not be limited to, for example, the employment needs of the user (e.g., job descriptions). The updates may be posted to other platform users who may, at their selection, choose to keep up-to-date with, or “follow”, other platform users.

Further, embodiments may enable users to refer specific individuals or companies to the fill the desired job description. Embodiments may enable the referred individual to see limited job description information (i.e., posted by a platform user) while excluding other information unless the referred individual accepts the referral through the platform. In this way, embodiments of the platform may help to ensure that the referring user gets credit for the referral.

Accordingly, embodiments may track referrals and may enable users to receive compensation for referrals. Further, embodiments may enable users to pass referrals to another user. In a case of a chain of referrals, embodiments of the present disclosure may then enable users in the referral chain to share the referral compensation. To facilitate the provision of quality referrals, embodiments of the present disclosure may enable users to rate referrals. The ratings may then be posted to the referring user's platform profile.

Still consistent with embodiments of the present disclosure, the platform may enable the users to contribute a portion of their referral cost to a fund of the user's choice. By way of non-limiting example, this fund may go towards supporting education. Then, in some embodiments, the amount of contributions made by the user may be displayed in the user's platform profile such that other users can see the contributions made. Each contribution may be referred to as a “BoonBack™”. The process of contributing may be referred to as “BooningBack™”

Consistent with the present disclosure, embodiments may include a messaging platform that may implement functions such as inbox sorting and filtering to facilitate user interaction. Embodiments of the present disclosure may further facilitate the referral fee transactions by implementing means to accept any type of payment method, including, but not limited to, Bitcoin, Stripe, PayPal, or an e-commerce rewards payment.

II. Platform Configuration

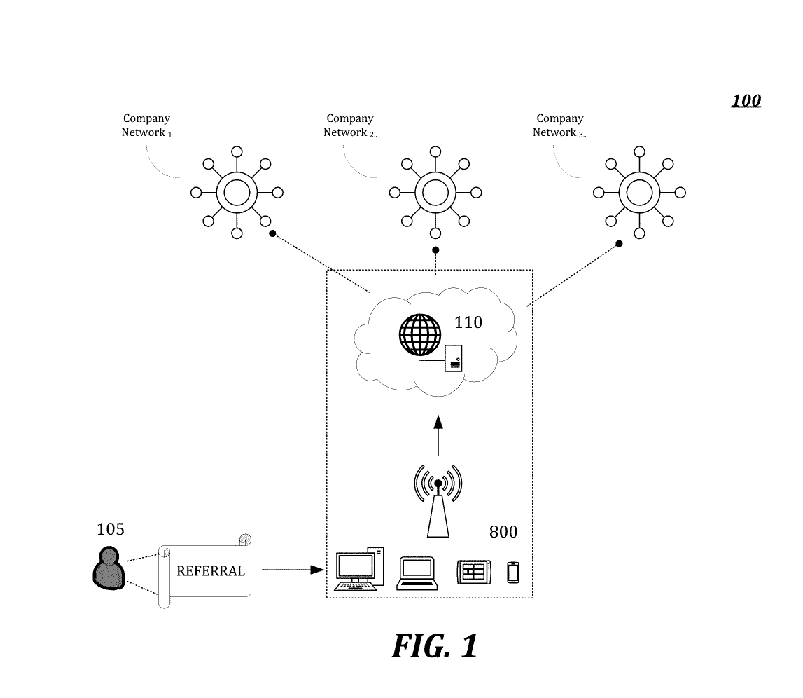

FIG. 1 illustrates one possible operating environment through which a platform consistent with embodiments of the present disclosure may be provided. By way of non-limiting example, a referral-recruiting platform 100 may be hosted on a centralized server 110, such as, for example, a cloud computing service. A user 105 may access platform 100 through a software application. The software application may be embodied as, for example, but not be limited to, a website, a web application, a desktop application, and a mobile application compatible with a computing device 800. The platform may be programmed in various programming languages including, but not limited to, for example, HTML, CSS and JavaScript. The backend may be written in languages such as, but not limited to, Ruby, Python or PHP. One possible embodiment of the software application may be provided by the Boon™ suite of products and services provided by Boon Company, Inc.

As illustrated in FIG. 1, users of platform 100 may either be individuals (e.g. user 105) or entities (e.g. Company Networks 1-3). Users and entities may be enabled to access the platform via server 110, but be provided with different features and functions—based on, for example, their membership type. Server 110, in turn, may connect, via platform 100, users and entities alike.

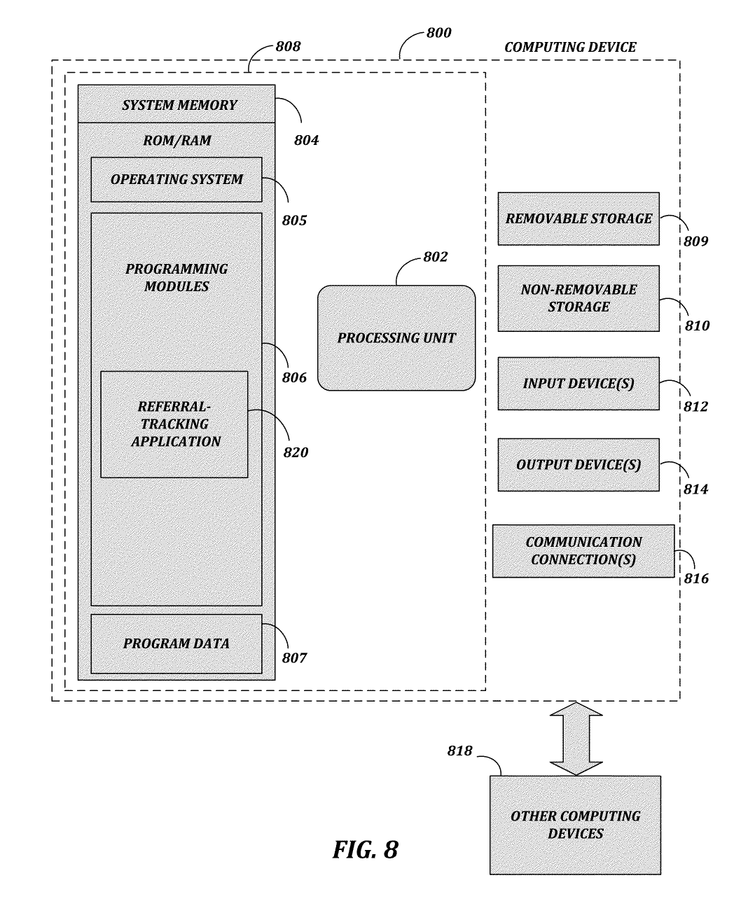

As will be detailed with reference to FIG. 8 below, the computing device through which the platform may be accessed may comprise, but not be limited to, for example, a desktop computer, laptop, a tablet, or mobile telecommunications device. As will be detailed with reference to FIG. 8 below, the computing device through which the platform may be accessed may comprise, but not be limited to, for example, a desktop computer, laptop, a tablet, or mobile telecommunications device.

III. Platform Operation

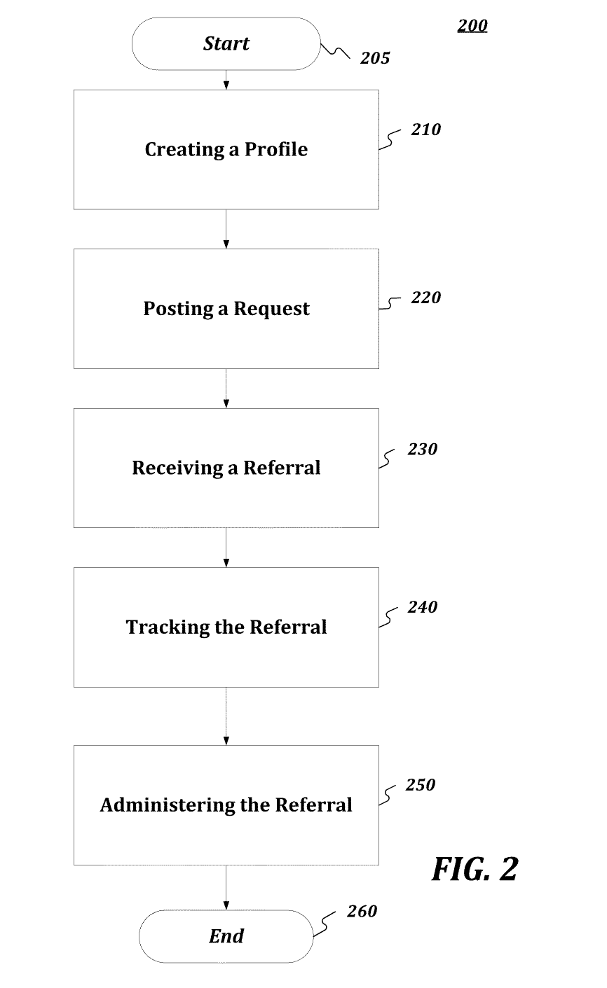

FIG. 2 is a flow chart setting forth the general stages involved in a method 200 consistent with an embodiment of the disclosure for providing a referral-recruiting platform 100. Method 200 may be implemented using a computing device 800 as described in more detail below with respect to FIG. 8.

Although method 200 has been described to be performed by platform 100, it should be understood that computing device 800 may be used to perform the various stages of method 200. Furthermore, in some embodiments, different operations may be performed by different networked elements in operative communication with computing device 800. For example, server 110 may be employed in the performance of some or all of the stages in method 200. Moreover, server 110 may be configured much like computing device 800.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 200 will be described in greater detail below.

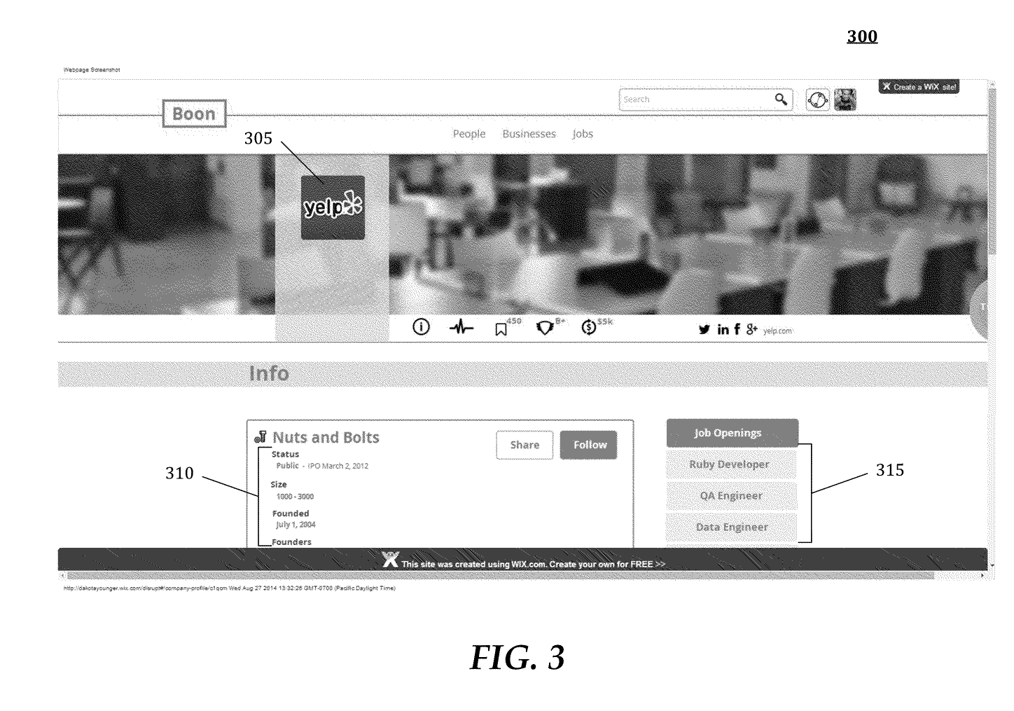

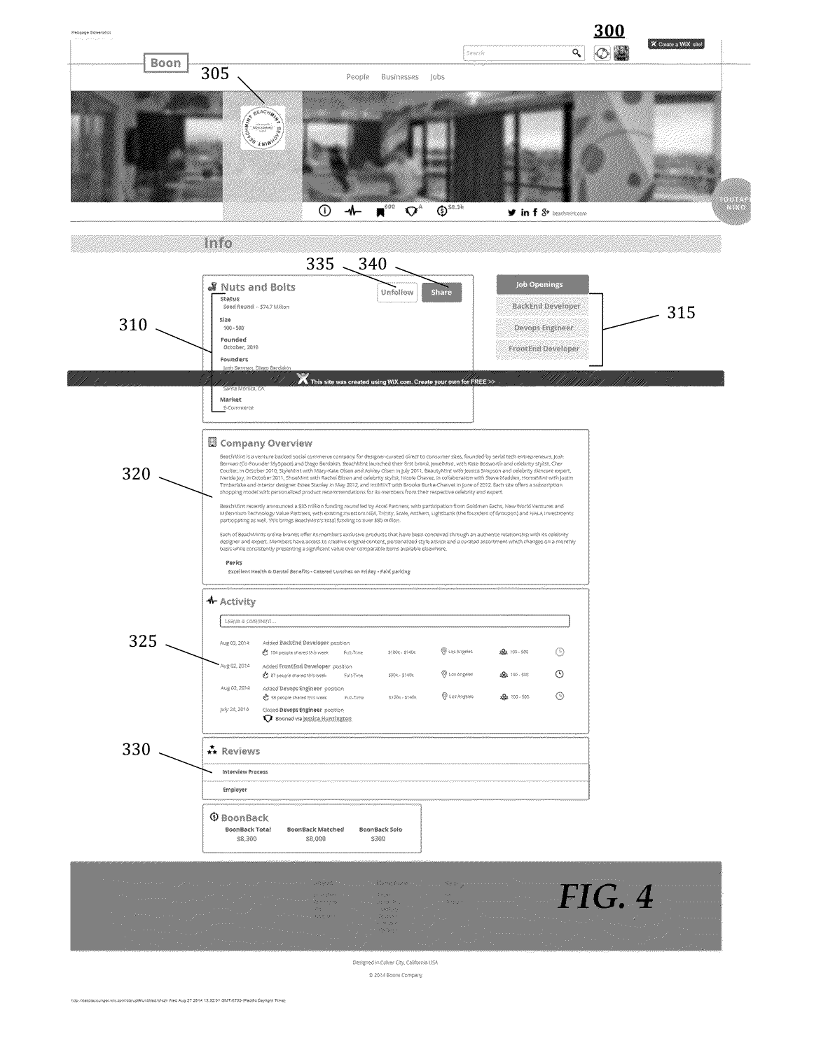

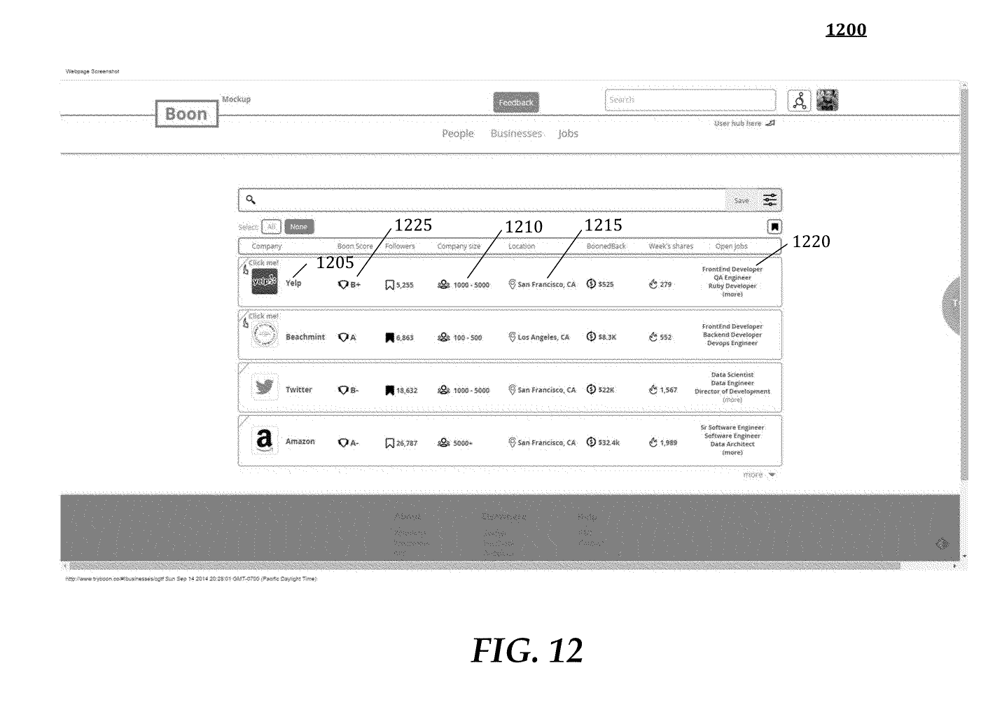

Method 200 may begin at starting block 205 and proceed to stage 210 where platform 100 may enable a user to create a profile. For example, a company may create a profile and add information including, but not limited to, location, status (public, private, startup, etc.), website, annual earnings, size, date founded, founder names, type of market, company overview, perks and available positions. FIG. 3 illustrates an example company profile 300 comprising a company name 305, company details 310, and available positions 315. FIG. 4 illustrates a more detailed example company profile 300, providing a company overview 320, recent activity 325 (e.g., recently posted positions and recently filled positions), and company reviews 330. FIG. 12 illustrates an interface 1200 in which a plurality of company profiles are displayed, including company name 1200, company size 1210, company location 1215, open jobs 1220, and user rating 1225.

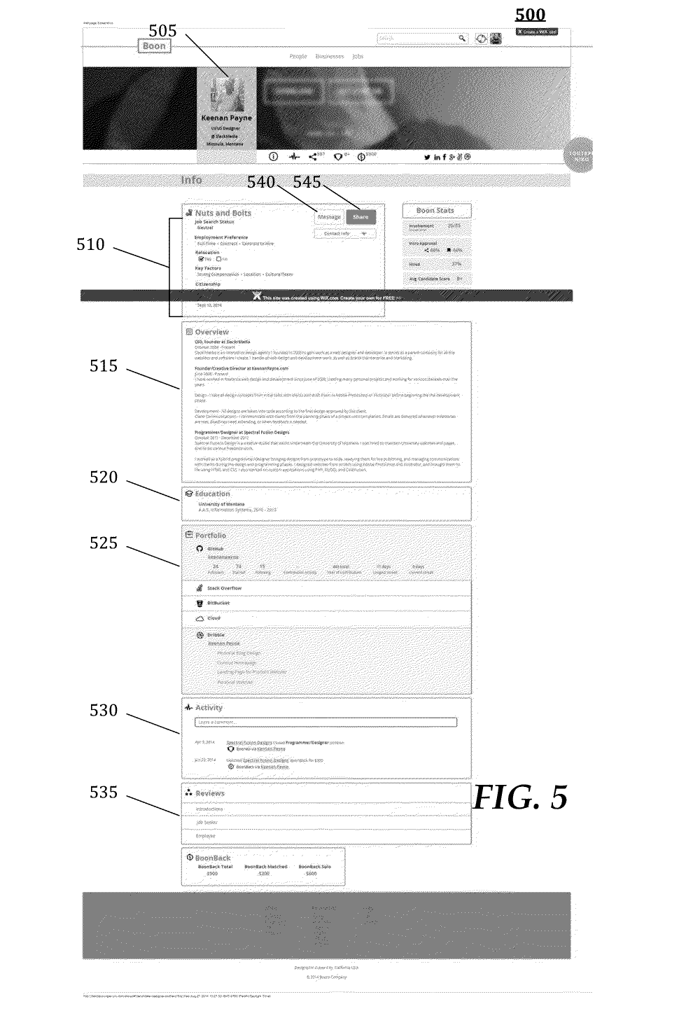

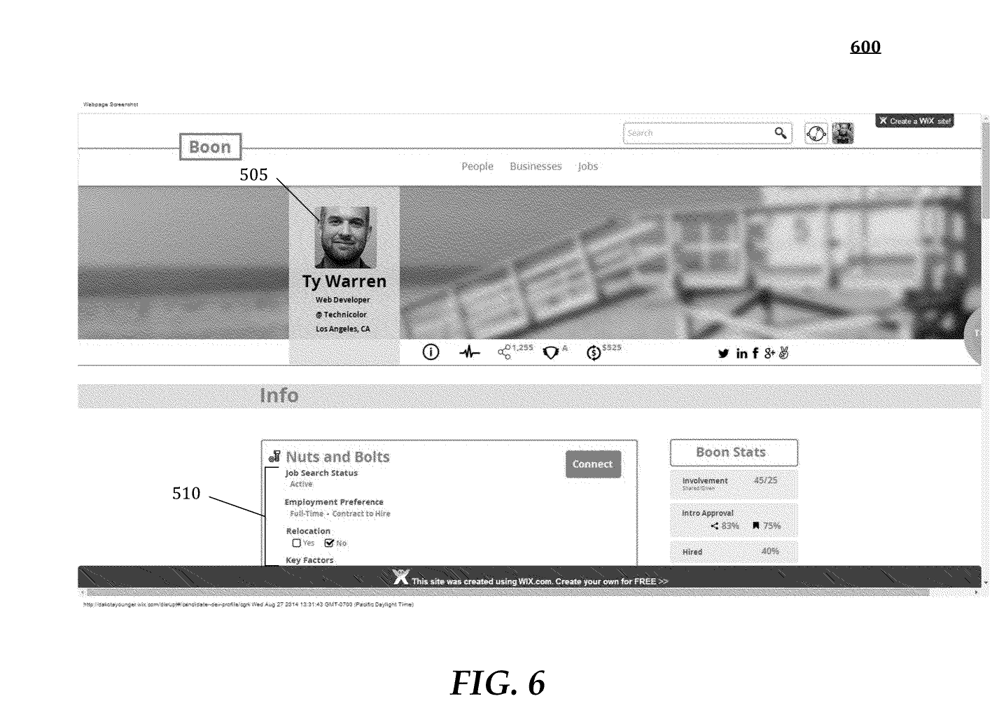

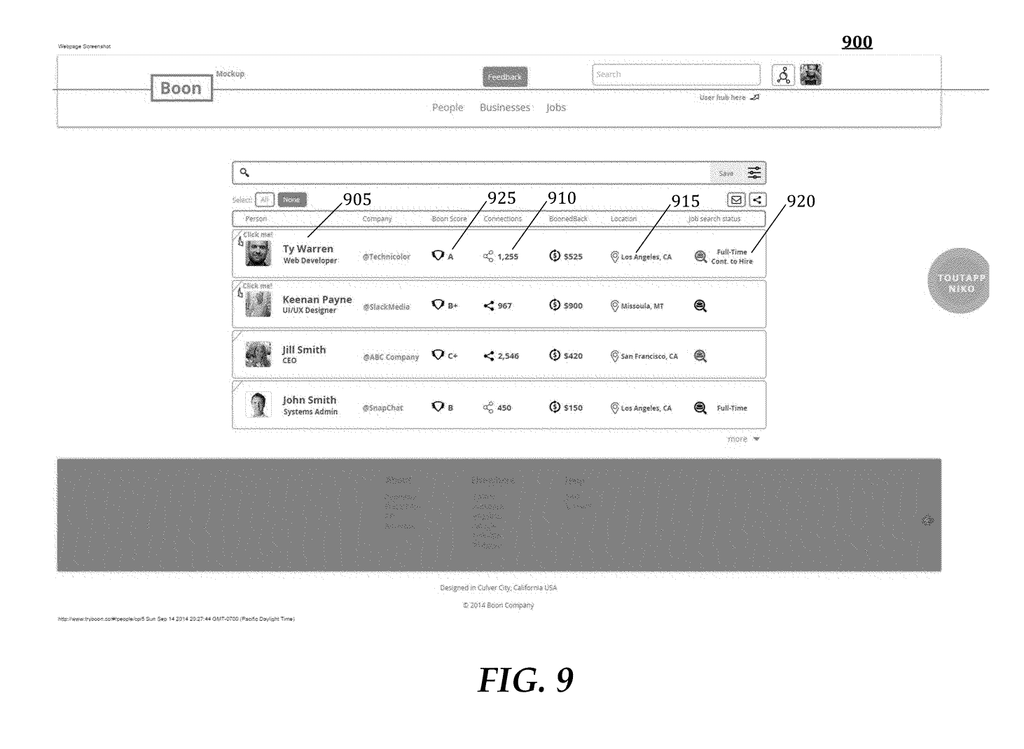

Similarly, a recruiter may create a profile and add information including, but not limited to, companies for which it would like to follow and send recruits, referral posts and company profile. Further still, individuals (e.g., potential candidates), herein referred to as “candidates,” may create profiles and add information including, but not limited to, their contact information, resume, employment status and employment preferences. FIG. 9 illustrates an interface 900 in which a plurality of candidate profiles are displayed. Interface 900 includes a user name 905, network connections 910, a location 915, a type of position desired 920 and a user score 925. In some embodiments, the platform 100 may be configured to retrieve user data from sources such as, but not limited to, LinkedIn, GitHub, StackOverflow, BeHance, Dribble and About Me. The retrieved data may then be posted to the corresponding user's profile. Example embodiments of potential candidate users are shown in FIGS. 5-6. FIG. 5 illustrates a user profile interface 500, including basic information 505, general information 510, an overview 515, education information 525, portfolio information 525, platform activity 530, and user review 535. User profile interface 500 further includes a message button 540 for enabling a recruiter, company, or other user to message the user associated with the user profile interface 500. Further, share button 545 may enable a user to share the user associated with the user profile interface 500 with another user. FIG. 6 illustrates an abbreviated user profile interface 600.

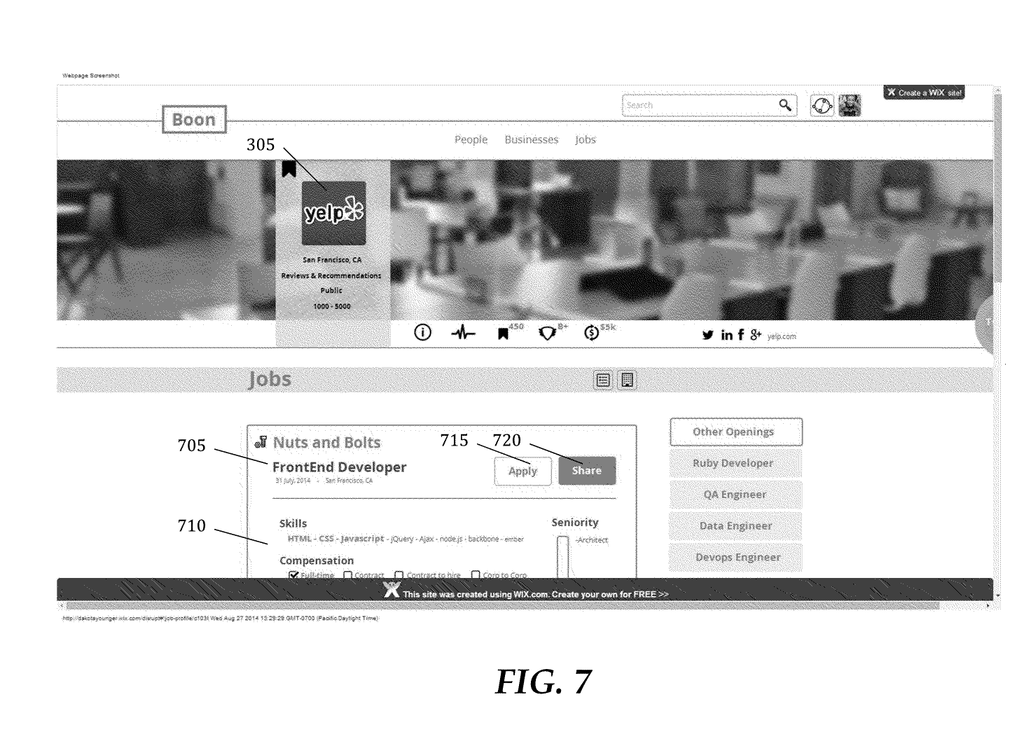

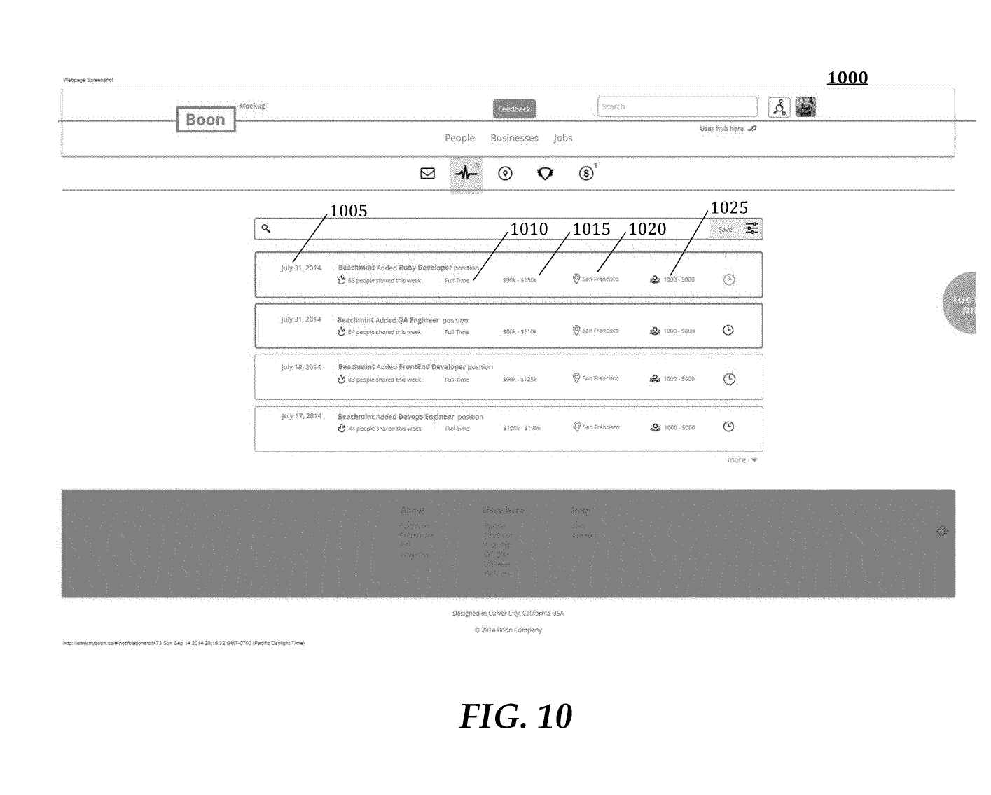

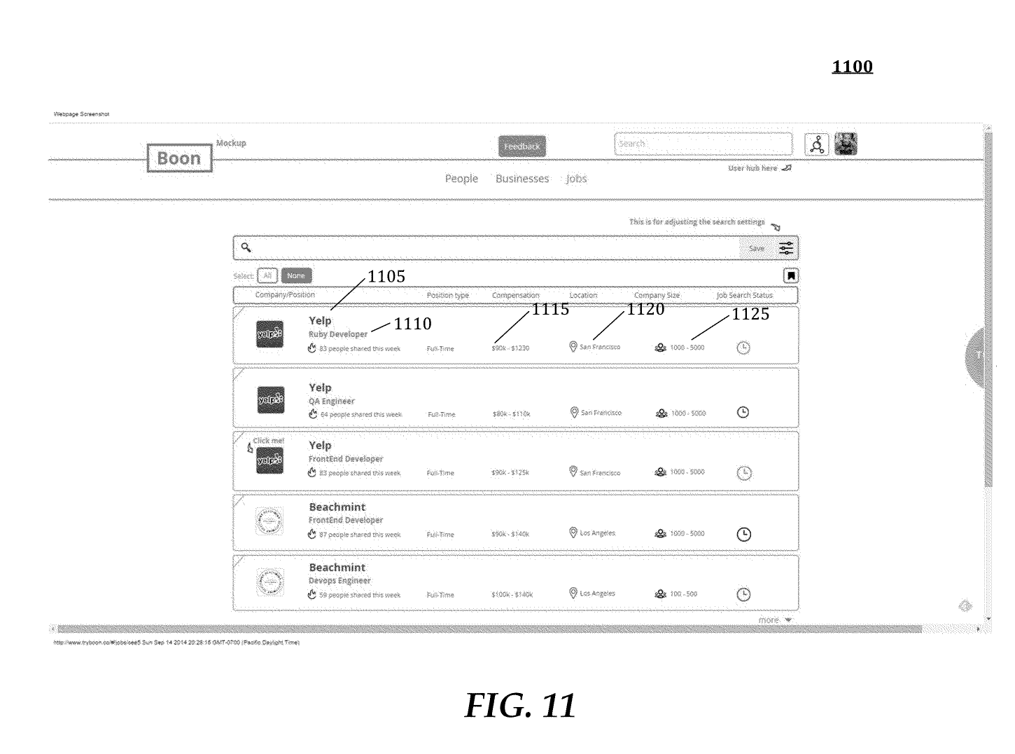

From stage 210, where platform 100 enables a user to create an account, method 200 may advance to stage 220 where platform 100 may enable the user to post a request. A request consistent with embodiments of the present disclosure may include, for example, but not be limited to, a job description. For example, a company may post information pertaining to available positions including, but not limited to, job title, description, skills required, compensation type and amount, relocation assistance, ability to work with visas and potential for remote work. In other embodiments, users may post goods and service descriptions describing the nature of the goods or services they are seeking for referral. An example embodiment of the job posting is shown in FIG. 7. Job posting 700 includes job title 705, job description 710, an apply button 715, and a share button 720. In some embodiments, a full listing of requests may be displayed in a notification-style interface, as illustrated in FIGS. 10-11 by referred positions interface 1000 and available positions interface 1100. In this way, abridged job information may be presented to the user from the recruiter. Referred positions interface 1000 includes date of referral 1005, type of position 1010, income range 1015, location 1020, and company size 1025. Interface 1100 includes company name 1105, job title 1110, salary range 1115, location 1120, and company size 1125.

Once platform 100 enables users to post a request in stage 220, method 200 may continue to stage 230 where platform 100 may enable a user to provide a referral in response to the request. The referral may be for an individual, entity, product, or service that may fulfill the request. In the event the request is a job description, the referral may be an individual who may be a candidate for the job. For example, the referring user may input the referred user's account information. In some embodiments, the referred user may not have an account with the platform and be sent an invite to join the platform. Once the referring user inputs the referred user's account info, the referred user may receive a notification of the referred position. Upon user-referral to a position, various embodiments may enable the referring user to claim priority referral for a designated amount of time, during which others cannot refer an individual to the same position.

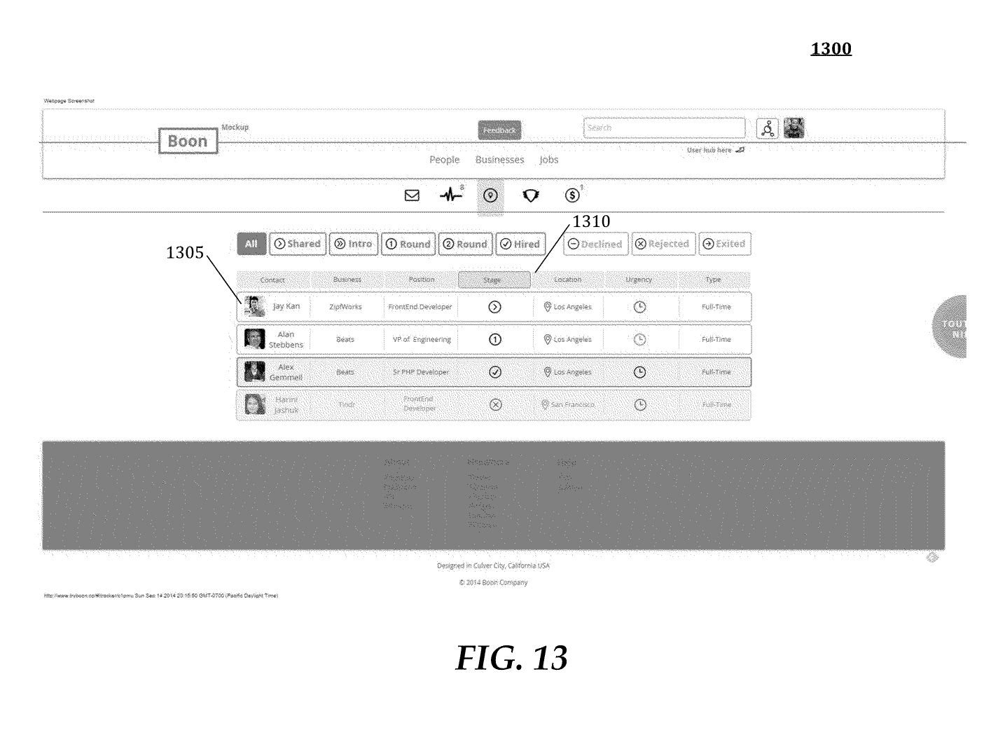

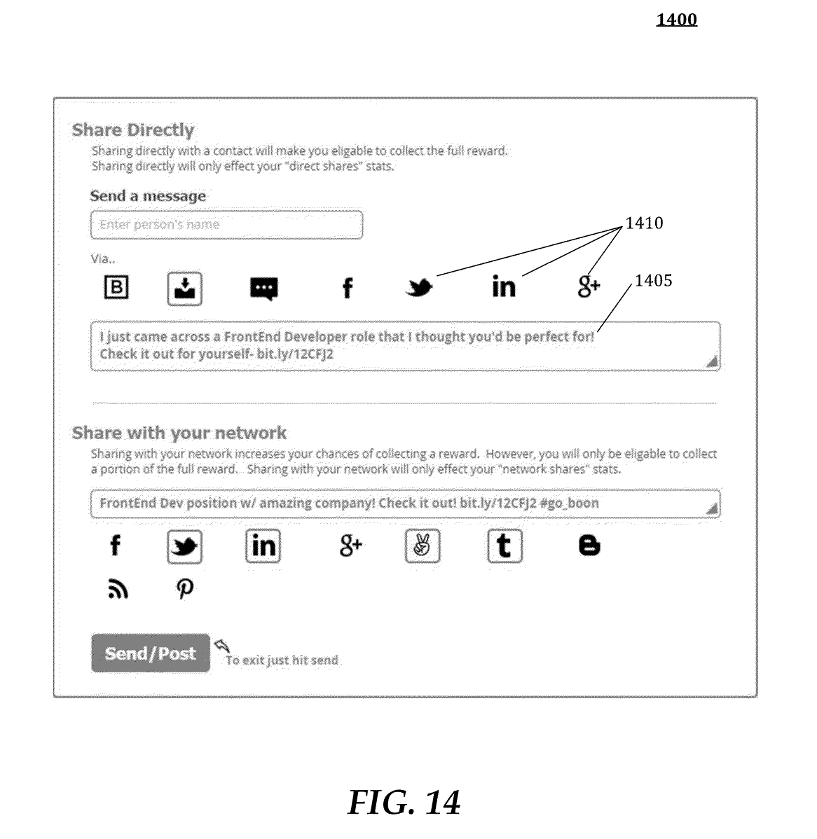

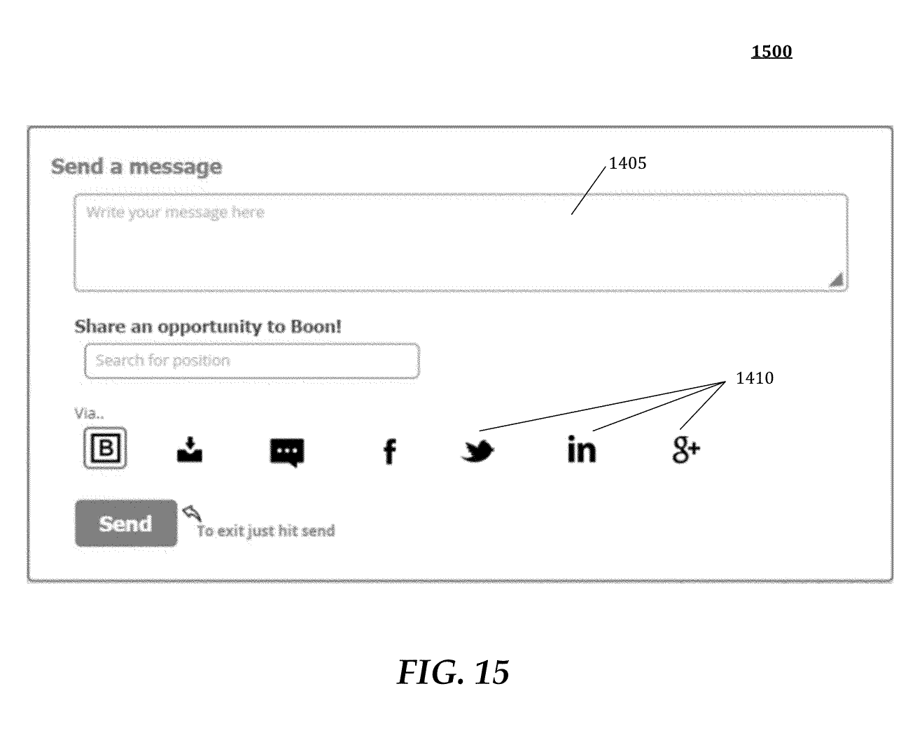

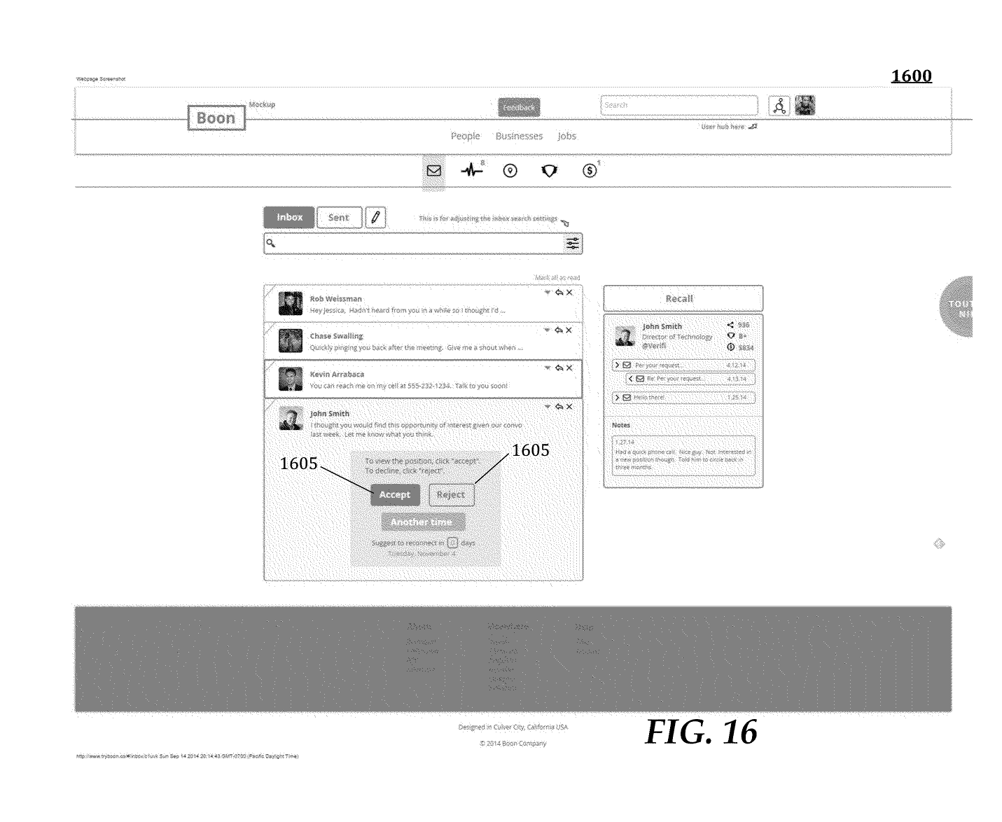

After platform 100 enables a user to refer an individual for an available position in stage 230, method 200 may proceed to stage 240 where platform 100 may track the referral process. For example, platform 100 may require the referred user to click a link before viewing the posting, which stores the information of the referring user. FIG. 13 illustrates an interface 1300 in which a user may be provided with a listing of tracked referrals. Interface 1300 comprises referred users 1305 and hiring stage 1310. Users may further be sorted by, for example, hiring stage 1310. If the recruited user accepts the offer, the user who posted the request (e.g. the job description) may have the opportunity to contact the recruited user (e.g., referred). Alternatively, the recruited user may forward the offer to another user who may accept the offer, in which case, the both referring parties would claim a portion of the recruitment fee. Subsequent referred users may continue forwarding the referrals to other users. FIG. 14 illustrates an interface 1400 in which a posting may be forwarded or shared with others. Interface 1400 may enable the referring user may send a message 1405 to a user through a selection among networks 1410. FIG. 15 illustrates an interface 1500 that enables a user to, for example, send messages, via the platform, to users outside of the platform. The entity receiving the referral may receive a message in an inbox associated with the platform. FIG. 16 illustrates an interface 1600 in which the referral may be displayed to a receiving entity. Interface 1600 includes accept button 1605 and reject button 1610 for accepting and rejecting the referral, respectively.

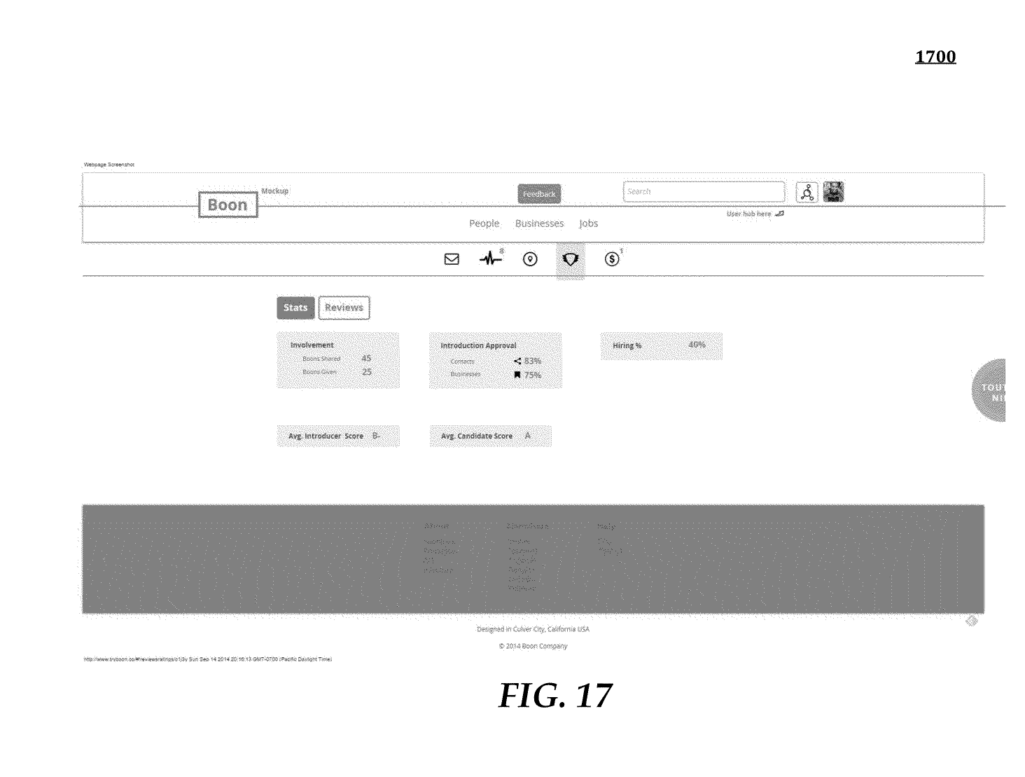

Once platform 100 tracks the referral process in stage 240, method 200 may then proceed to stage 250 where platform 100 may administer a referral process. Administering the referral process may include, for example, but not be limited to, a sharing of referral fees and an issuance of a referral rating. For example, the hiring entity (e.g., companies) may rate the quality of the referred users, including, but not limited to whether or not the user was hired as well as how far along the hiring process each referred user reached. The ratings may be posted on the referring user's profile such that other users can see how reliable the referrals are. FIG. 17 illustrates an interface 1700 in which a user's ratings are displayed. Interface 1700 comprises reviews by job-seeking users 1705, reviews by companies 1710, number of referrals given 1715, number of referrals shared 1720, hiring percentage 1725, hiring introducer score 1730 and hiring candidate score 1735.

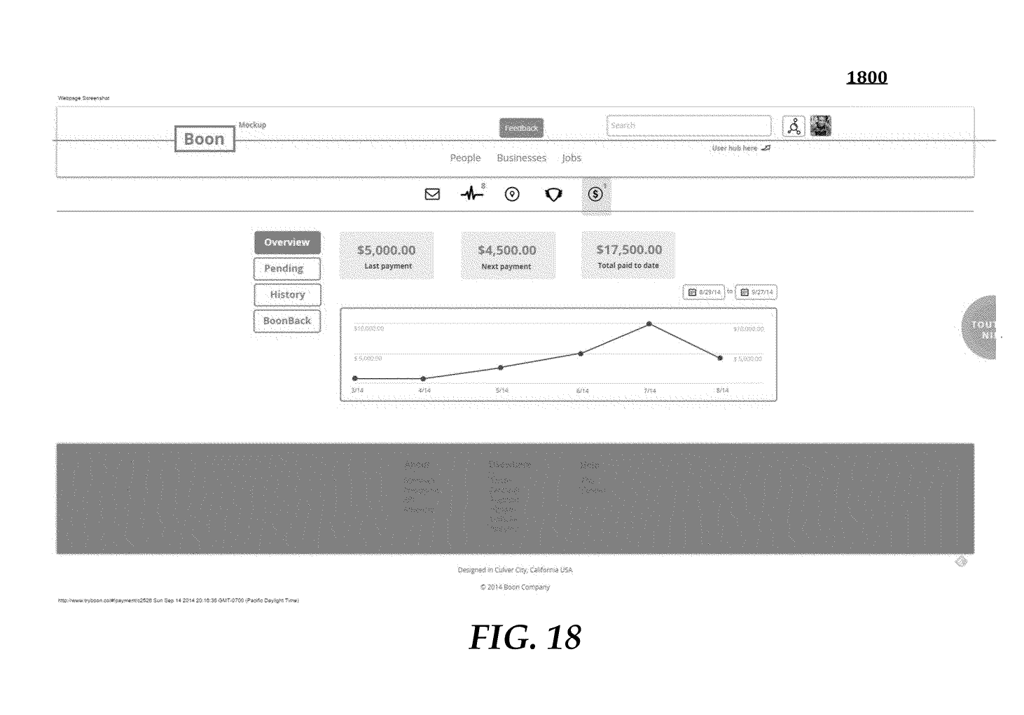

Still consistent with embodiments of the present disclosure, if a user with an open position decides to hire a recruited user, the user referring user may be compensated. In addition, a portion of the referral fee may be given to a charitable organization, including, but not limited to education. FIG. 18 illustrates one embodiment of a payment interface 1800. Once platform 100 tracks the referral process in stage 240, method 200 may then end at stage 260.

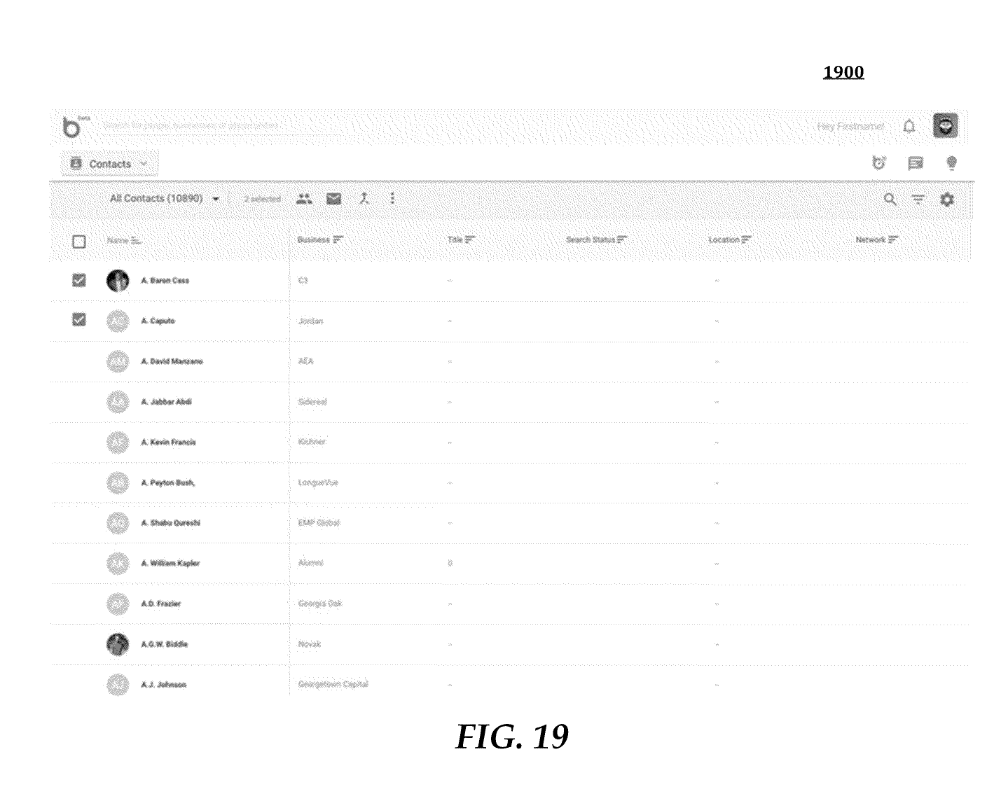

Platform 100 may further enable an individual to upload users into his/her network to manage whom in the individual's network the individual may refer to job opportunities by using a contact manager. Further, the platform's contact manager may recommend referrals from data stored on the list via a matching feature. For example, the platform may enable the individual to upload contacts into the contact manager by manually entering a contact. Alternatively, the platform may enable the individual to upload contacts by importing from the individual's Google contact list, by importing a .csv file from LinkedIn, and by importing other various stored contact formats. The uploaded contacts may be merged together with existing contacts to combine contact information into one profile (a “contact list”). In further embodiments, contacts may be automatically synched from third-party platforms. FIG. 19 illustrates contact list 1900. Uploaded contacts then be manipulated. For example, they may be sorted, edited, categorized, tagged, and searched. The platform may parse data from the contact list to display potential referral matches to job opportunities within the platform. The referral matches may be represented, for example, by a percent match.

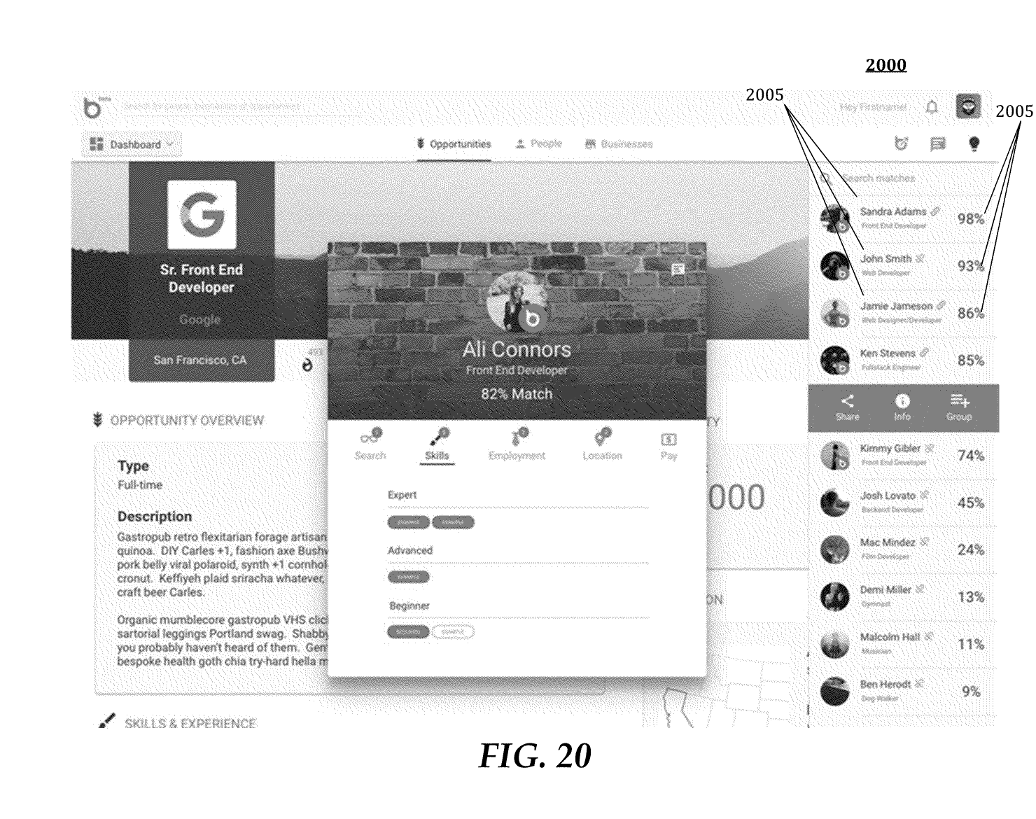

Using the data from the contact list, the platform may provide referral suggestions. These references may be made, for example, by cross-referencing contact data with job opportunity data. Matches may be represented as a percent fitness of the match (“matching score”). Certain data points may increase the matching percentage, such as, for example, but not limited to location, job title, and skills. Matching scores may be provided through the platform. IN some embodiments, the matching scores may be displayed on a job opportunities page. FIG. 20 illustrates job opportunities page 2000 as well as the matches 2005 and match percentages 2010. In this way, real-time matches may be provided to an individual browsing each job opportunity.

IV. Platform Architecture

The referral-recruiting platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, platform 100 may be hosted on a centralized server, such as, for example, a cloud computing service. Although method 200 has been described to be performed by a computing device 800, it should be understood that, in some embodiments, different operations may be performed by different networked elements in operative communication with computing device 800.

FIG. 8 is a block diagram of a system including computing device 800. Consistent with an embodiment of the disclosure, the aforementioned memory storage and processing unit may be implemented in a computing device, such as computing device 800 of FIG. 8. Any suitable combination of hardware, software, or firmware may be used to implement the memory storage and processing unit. For example, the memory storage and processing unit may be implemented with computing device 800 or any of other computing devices 818, in combination with computing device 800. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure may include a computing device, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination. System memory 804 may include operating system 805, one or more programming modules 806, and may include a program data 807. Operating system 805, for example, may be suitable for controlling computing device 800's operation. In one embodiment, programming modules 806 may include referral tracking account database management. Furthermore, embodiments of the disclosure may be practiced in conjunction with a graphics library, other operating systems, or any other application program and is not limited to any particular application or system. This basic configuration is illustrated in FIG. 8 by those components within a dashed line 808.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a touch input device, etc. Output device(s) 814 such as a display, speakers, a printer, etc. may also be included. The aforementioned devices are examples and others may be used.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 804, including operating system 805. While executing on processing unit 802, programming modules 806 (e.g., referral-tracking application 820) may perform processes including, for example, one or more of method 200's stages as described above. The aforementioned process is an example, and processing unit 802 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method comprising:
receiving a user profile associated with a first candidate;
receiving a company profile associated with a company;
receiving a job posting from the company;
receiving a referral for the job posting from a referring user, wherein receiving the referral for the job posting comprises:
receiving an association of the job posting and the first candidate, and
providing the job posting to the first candidate;
tracking the referral, wherein tracking the referral comprises:
associating the referral with the referring user and the first candidate, and
preventing other users from referring the job posting to the first candidate; and
administering the referral, wherein administering the referral comprises providing a referral fee to the referring user.

2. The method of claim 1, further comprising:
enabling the candidate to forward the referral to a second candidate, and
wherein administering the referral further comprises providing a portion of the referral fee to the first candidate.

3. The method of claim 1, wherein administering the referral comprises receiving a rating of at least one of the following: the first candidate, the referring user, and the company.

4. The method of claim 3, further comprising displaying the rating of the at least one of the first candidate, the referring user, and the company, to a profile page associated with the at least one of the first candidate, the referring user, and the company.

5. The method of claim 1, further comprising displaying the company's profile page to at least one of the following: the referring user and the first candidate.

6. The method of claim 1, further comprising displaying the first candidate's profile page to at least one of the following: the referring user and the company.

7. The method of claim 1, further comprising: enabling the referring user to donate a portion of the referral fee to a charity.

8. The method of claim 7, further comprising:
aggregating the donated portion of the referral fee with the referring user's previous donations to determine an aggregated donation amount; and
displaying the aggregated donation amount to other users.

9. The method of claim 1, wherein providing the job posting to the first candidate comprises providing the first candidate with at least one of the following: a link and a brief description of the job posting.

10. The method of claim 9, wherein the user is precluded from viewing a complete display the job posting without selecting the link.

11. The method of claim 1, wherein the job posting comprises: a job title, a job description, a referral fee amount, and a salary range.

12. The method of claim 1, wherein providing the job posting to the first candidate comprises providing the job posting to the first candidate via a social media platform.

13. The method of claim 1, further comprising: enabling the recruiting user to follow at least one of the following: the first candidate and the company, wherein following comprises providing a notification to the recruiting user when a status associated with the at least one of the first candidate and the company changes.

14. The method of claim 1, further comprising:
enabling the first candidate to apply to the job posting.

15. A computer-readable medium comprising a set of instructions, which when executed perform a method comprising:
receiving a user profile associated with a first candidate;
receiving a company profile associated with a company;
receiving a job posting from the company;
receiving a referral for the job posting from a referring user, wherein receiving the referral for the job posting comprises:
receiving an association of the job posting and the first candidate, and
providing the job posting to the first candidate;
tracking the referral, wherein tracking the referral comprises:
associating the referral with the referring user and the first candidate, and
preventing other users from referring the job posting to the first candidate; and
administering the referral, wherein administering the referral comprises providing a referral fee to the referring user.

16. The computer readable medium of claim 15, wherein providing the job posting to the first candidate comprises providing the first candidate with at least one of the following: a link and a brief description of the job posting.

17. The computer readable medium of claim 16, wherein the user is precluded from viewing a complete display the job posting without selecting the link.

18. A system comprising:
A memory storage; and
A processing unit coupled with the memory storage, wherein the processing unit is operative to:
receive a user profile associated with a first candidate;
receive a company profile associated with a company;
receive a job posting from the company;
receive a referral for the job posting from a referring user, wherein the referral for the job posting comprises:
an association of the job posting and the first candidate, and
a provision of the job posting to the first candidate;
associate the referral with the referring user and the first candidate,
and
prevent other users from referring the job posting to the first candidate; and
provide a referral fee to the referring user.

19. The system of claim 18, wherein the provision of the job posting to the first candidate comprises at least one of the following a link and a brief description of the job posting.

20. The system of claim 19, wherein the processing unit is further operative to preclude the user from viewing a complete display the job posting without selecting the link.
